(19) United States
(12) Patent Application Publication
(10) Pub. No.: US 2003/0188146 A1
(43) Pub. Date: Oct. 2, 2003

(54) Method of ordered execution of firmware modules in a pre-memory execution environment

(76) Inventors: Robert P. Hale, Portland, OR (US); William A. Stevens, Folsom, CA (US); Kirk D. Brannock, Olympia, WA (US); Rahul Khanna, Beaverton, OR (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/112,920

(22) Filed: Mar. 28, 2002

(51) Int. Cl. G06F 9/00; G06F 9/24

(52) U.S. Cl. 713/1

(57) ABSTRACT

The present invention provides a mechanism for independently developed firmware modules to be executed in an ordered sequence such that the services required by each module will be available when the module executes. Upon execution, each of the firmware modules provides one or more services that may be used by various components in the computer platform. In one embodiment, one or more firmware modules are stored on one or more firmware devices (FD), such as a flash memory component or other types of non-volatile storage mediums. The mechanism examines header information pertaining to each of the firmware modules in each FD and determines services that are required to be available prior to the execution of that module. Firmware modules are then executed in an order that is a function of the services each module requires (i.e., is dependent on) and the services each module produces using an iterative algorithm.

### BACKGROUND OF THE INVENTION

1. Field of the Invention

The present invention concerns computer platform firmware in general, and concerns a method for ordering execution of multiple firmware modules in a pre-memory execution environment in particular.

2. Background Information

Computer platform firmware is used during initialization of computer systems to verify system integrity and configuration. It also generally provides the basic low-level interface between hardware and software components of those computer systems, enabling specific hardware functions to be implemented via execution of higher-level software instructions contains in computer programs that run on the computer systems. In many computers, a primary portion of this firmware is known as the Basic Input/Output System (BIOS) code of a computer system. The BIOS code comprises a set of permanently recorded (or semi-permanently recorded in the case of systems that use flash BIOS) software routines that provides the system with its fundamental operational characteristics, including instructions telling the computer how to test itself when it is turned on, and how to determine the configurations for various built-in components and add-on peripherals.

In a typical PC architecture, the BIOS is generally defined as the firmware that runs between the processor reset and the first instruction of the Operating System (OS) loader. This corresponds to the startup operations performed during a cold boot or in response to a system reset. At the start of a cold boot, very little of the system beyond the processor and firmware is actually initialized. It is up to the code in the firmware to initialize the system to the point that an operating system loaded off of media, such as a hard disk, can take over.

There is generally a required order to the initialization done by the firmware. For example, a hard disk cannot be used until its controller is initialized. Likewise, the controller cannot be used until the bus it is on is initialized. As such, the order required for a proper initialization would be to first initialize the bus, then the controller, and finally the hard disk.

Typically, firmware code is stored in a “monolithic” form comprising a single set of code that is provided by a platform manufacturer or a BIOS vendor such as Phoenix or AMI. Various portions of the single set of code are used to initialize different system components. Since there is only a single set of code, the order in which these system components are initialized is easily defined within the BIOS code itself by the developer. In other situations, a monolithic BIOS may be extended using one or more “Option ROMs” that are contained on one or more periphery device cards. For example, SCSI device driver cards and video cards often include an option ROM that contains BIOS code corresponding to services provided by these cards. Typically, firmware in option ROMs is loaded after the firmware in the monolithic BIOS has been loaded or during loading of the monolithic BIOS in accordance with a predefined ordering scheme.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a block schematic diagram of a firmware architecture in accordance with one embodiment of the invention;

FIG. 2 is a flowchart illustrating the logic used by a dispatcher to determine a dispatch order of a plurality of firmware modules in accordance with one embodiment of the invention;

FIG. 3 is a schematic block diagram illustrating a register-based storage scheme that is used to store dispatch data in accordance with one embodiment of the invention;

FIG. 4 is a flowchart illustrating the logic used by the dispatcher to determine if all of the services required by a given firmware module have been produced prior to dispatch of that firmware module in accordance with one embodiment of the invention;

FIG. 5 is a schematic diagram illustrating a plurality of 64-bit registers that may be used to facilitate storage operations corresponding to the flowchart of FIG. 4; and

FIG. 6 is a schematic diagram of an exemplary computer system in which the invention may be implemented.

### DETAILED DESCRIPTION OF THE ILLUSTRATED EMBODIMENTS

A method and architecture for defining execution order of a plurality of firmware modules in a pre-memory execution environment is described in detail herein. In the following description, numerous specific details are disclosed to provide a thorough understanding of embodiments of the invention. One skilled in the relevant art will recognize, however, that the invention can be practiced without one or more of the specific details, or with other methods, components, etc. In other instances, well-known structures or operations are not shown or described in detail to avoid obscuring aspects of various embodiments of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The present invention provides a mechanism for independently developed firmware modules to be executed in an ordered sequence such that the services required by each module will be available when the module executes. Upon execution, each of the firmware modules provides one or more services that may be used by various components in the computer platform. In one embodiment, one or more firmware modules are stored on one or more firmware devices (FD), such as a flash memory component or other types of non-volatile storage mediums. The mechanism examines header information pertaining to each of the firmware modules in each FD and determines services that are required to be available prior to the execution of that module. Firmware modules are then executed in an order that is a function of the services each module requires (i.e., is dependent on) and the services each module produces using an iterative algorithm. The mechanism is designed to work with very few resources, such as is common during early boot operations when resources such as main memory is not yet available. For example, one embodiment of the invention may be implemented where memory availability is limited simply to the registers in the processor's context or is extremely small (e.g., <4k bytes).

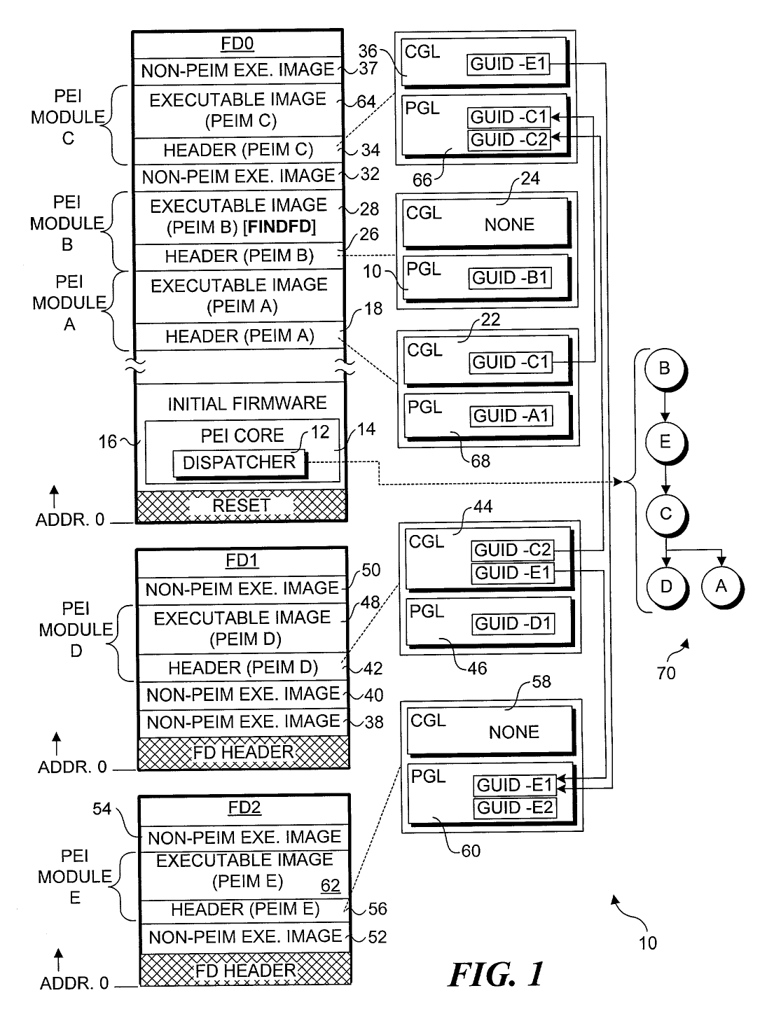

A firmware architecture 10 corresponding to one embodiment of the invention is shown in FIG. 1. Architecture includes three firmware devices FD0, FD1, and FD2, each of which includes code corresponding to one or more Pre EFI (Extended Firmware Interface) Initialization (PEI) Modules (also referred to herein as PEIMs) and other executable images used for platform initialization/firmware purposes. For example, firmware device FD0 includes PEI modules A, B, and C, firmware device FD1 includes a PEI module D and firmware device FD2 includes a PEI module E.

Each of the PEI modules comprises a plurality of coded data and instructions stored in as an executable image (i.e., body) that when executed enables that PEI module to provide one or more services corresponding to the module. Each PEI module further includes a header that generally contains information about the executable image (e.g., authorship, checksumming or validation data, etc.) and further contains information pertaining to services the module requires (“consumes”) before it may be usefully executed and services the module makes available (“produces”) upon execution. In one embodiment, these services are stored in respective lists known as the Consumes GUID List (CGL) and the Produces GUID List (PGL), wherein each list contains none or more GUIDs (Globally Unique Identifiers), each of which comprises a 128-bit value that is generated using a standard algorithm that is well-known in the art. As explained in further detail below, the GUIDs in the CGLs and PGLs are processed by an execution ordering algorithm to define a “weak” ordering by which the PEI modules may be executed such that the services described in the CGL for each PEI module are available prior to execution of that module.

In one embodiment, the execution ordering algorithm is performed by a dispatcher 12 contained in a PEI core portion 14 of an initial set of firmware instructions 16 that is executed in during a boot operation or in response platform reset event. For example, upon starting up a computer system containing various firmware stored in firmware devices FD0, FD1, FD2, the first initialization code executed by the system's processor begins at the boot vector, which will typically be contained in a boot firmware device (BFD); the BFD in this example is FD0. The boot vector, which will be mapped to a predefined address, points to the first instruction in a set of “early” firmware that is used to initialize the computer system (i.e., initial set of firmware instructions 16). Upon execution of these firmware instructions, PEI core portion 14 is executed, launching dispatcher 12, which then performs the execution ordering algorithm.

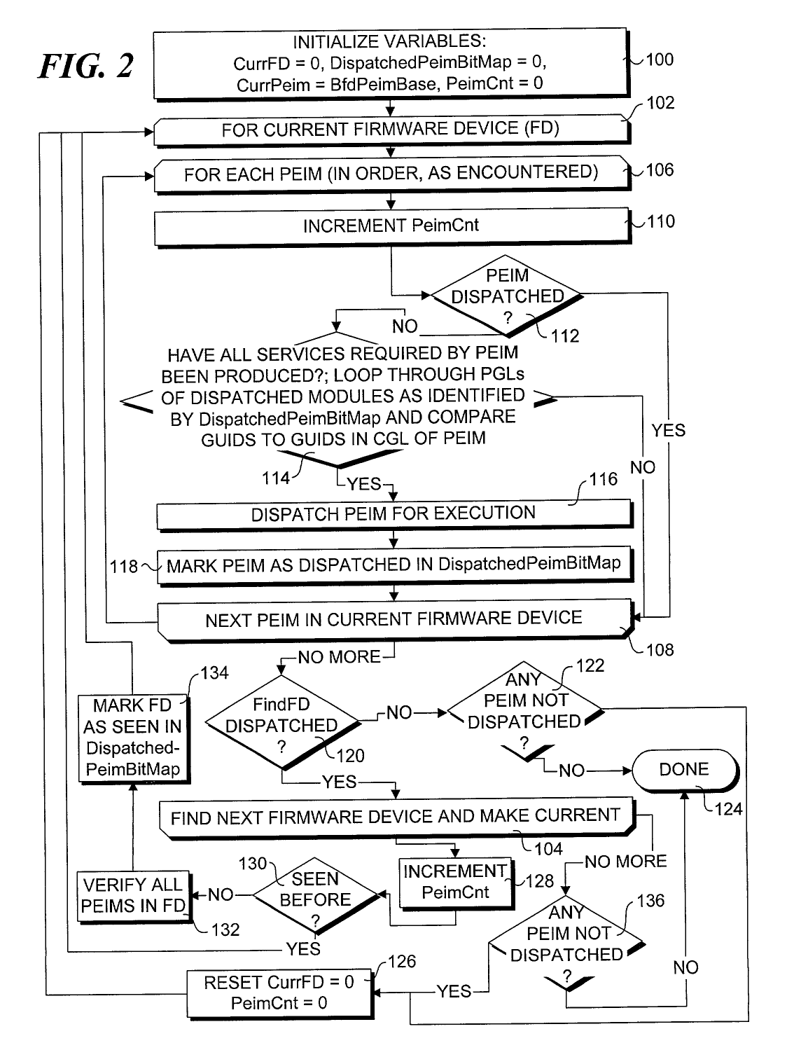

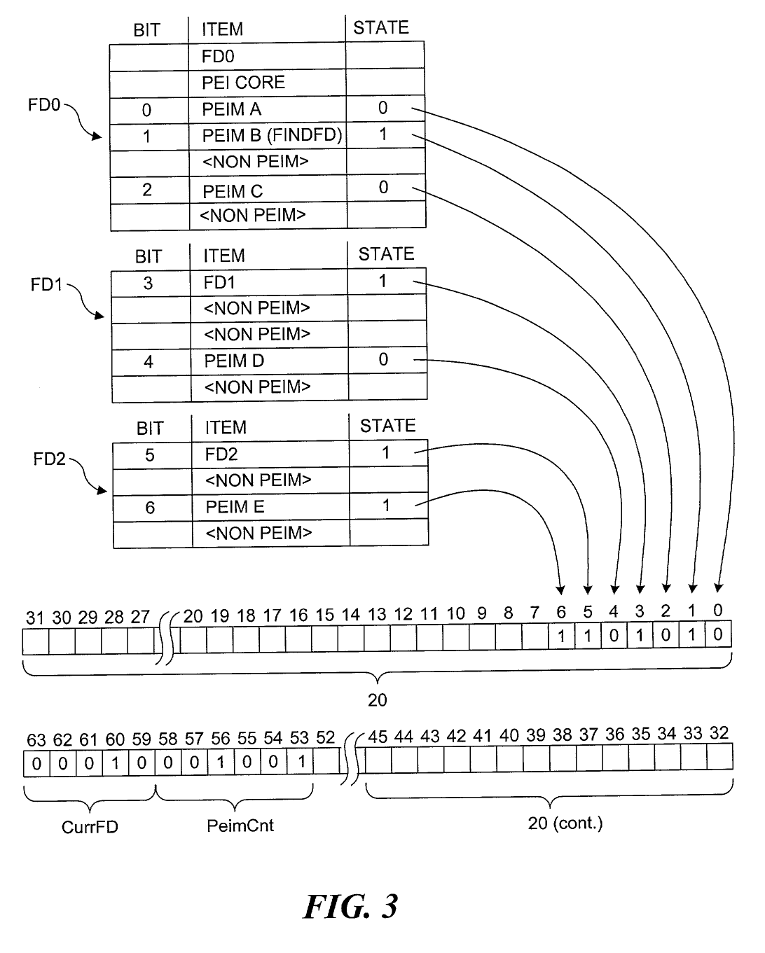

A flowchart corresponding to one embodiment of the execution ordering algorithm is shown in FIG. 2. The algorithm begins by initializing various variables in a block 100, including setting the current firmware device (CurrFD) to 0 (i.e., FD0), clearing all of the bits in a DispatchedPeimBitMap described below with reference to FIG. 3, setting the current PEI module to a base PEI module in the BFD (CurrPeim=BfdPeimBase) and setting the PEI module count (PeimCnt) to 0. Next, the operations generally contained within start and end loop blocks 102 and 104 are performed for each of the firmware devices containing the PEI modules for the computer platform, beginning with firmware device FD0.

Dispatcher 12 parses the data and instruction code of the current firmware device looking for PEI modules, which are identified by a PEIM type identifier in their corresponding PEIM headers. As each PEI module is identified, a set of operations pertaining to that PEI module is performed, as defined by operations disposed between start and end loop blocks 106 and 108. These operations begin in a block 110, wherein the PEIM count (i.e., the PeimCnt value) is incremented. The PEIM count is incremented when either a new PEI module is encountered, or a new firmware device is found, as described below in further detail. The count begins at 0 and is not incremented for either FD0 or when PEI core portion 14 is executed. In the current example, upon encountering a PEIM header 18 corresponding to PEI module A, the PEIM count is incremented by 1 so that PeimCnt=1.

With reference to FIG. 3, the PEIM count is used for determining bit locations in a DispatchedPeimBitMap 20, which in turn is used to identify which PEI modules have been executed and which FDs have been validated. In one embodiment, DispatchedPeimBitMap 20 is stored in one or more processor or chipset registers, such as a 64-bit MMX register that is common to many INTEL® processors. In one embodiment, values for CurrFD and PeimCnt may also be stored in one or more similar registers, or the same register, such as shown in FIG. 3.

Next, in a decision block 112, a determination is made to whether the PEIM has been previously dispatched. Since this is the first time PEI module A has been encountered, it cannot have been previously dispatched, and the answer to decision block 112 is NO (FALSE), causing the logic to proceed to a decision block 114. In decision block 114, a determination is made to whether all services required for the current PEI module have been produced through dispatch of other PEI modules the current PEI module may be dependent on and/or services that are provided by through execution of the early firmware. This determination is performed by parsing the CGL of the current PEIM to determine the GUIDs for the required services to enable proper execution of the current PEIM and then looping through the PGLs of all of the PEIMs that have been dispatched (as identified by DispatchPeimBitMap 20) and comparing the GUIDs in these PGLs with the GUIDs in the current PEIM's CGL. For example, as specified by a CGL 22 contained in header 18, PEI module A consumes (i.e., requires or is dependent on) a service having a GUID of C1. (It is noted that simply GUIDs rather than 128-bit GUIDs are used in the exampled illustrated in the Figures and discussed herein for clarity.) As discussed above, DispatchPeimBitMap 20 is initialized such that the values for all of the bit positions are set to 0's (indicating that each bit's corresponding PEIM has yet to be dispatched). Accordingly, when PEIM module A is first encountered, the DispatchPeimBitMap accurately reflects that no PEIMs have been dispatched. As a result, there are no PGLs to loop through and the result of decision block 112 is NO (FALSE). In response, the logic is caused to loop back to start loop block 106 to begin processing the next PEIM that is encountered in the current FD.

Continuing with the example corresponding to the firmware device configuration illustrated in FIG. 1, the next PEIM encountered is PEI module B. As before, the PeimCnt is incremented in block 110 and a determination is made in block 112 to whether the PEIM has been previously dispatched. Again the answer is NO, and the logic proceeds to decision block 114, wherein a determination is made to whether all of the services required by PEI module B have been produced. As provided by a CGL 24 contained in a header 26 corresponding to PEI module B, there are no services required to be dispatched prior to dispatching PEI module B. As a result, the answer to decision block 114 is YES (TRUE), and the logic proceeds to a block 116 in which an executable image 28 corresponding to PEI module B is dispatched for execution. Upon being executed, a PEI module provides all of the services identified by the GUID(s) in its corresponding PGL. In this instance, a single service having a GUID of B1 is provided, as identified by a PGL 30 corresponding to PEI module B that is contained in header 26. Next, in a block 118, the PEIM is marked as dispatched by setting a bit corresponding to the current PeimCnt value to 1 in the DispatchedPeimBitMap. In the current example, the current PeimCnt value is 1, so a bit 1 in DispatchedPeimBitMap 20 is set to 1. The logic then again loops back to start block 106 to begin processing the next PEIM.

In this instance, a header for a non-PEIM executable image 32 will be encountered prior to encountering a header 34 corresponding to PEI module C. Each of the PEIM headers is encoded to identify it has a header corresponding to a PEIM module. In contrast, the headers corresponding to non-PEIMs are encoded with a different type of identifier (if at all), enabling dispatcher 12 to easily distinguish between the two. In generally, dispatcher 12 simply ignores non-PEIMs and proceeds to the next PEIM.

Upon encountering header 34, the PeimCnt value is incremented in block 110 and the result of decision block 112 is again NO, since this is the first time that PEI module C has been encountered. As provided by a CGL 36, PEI module C requires a service having a GUID of E1 to be dispatched prior to it being available for proper execution. Accordingly, the operation of decision block 114 first examines the DispatchedPeimBitMap to determine which PEI modules have been dispatched. In this instance, only PEI module B has been dispatched, providing a service having a GUID of B1. Since there are no dispatched services having a GUID of E1 at this time, the answer to decision block 114 is NO, and the logic proceeds to end loop block 108 to find the next PEIM in firmware device FD0. This time the next header that is encountered corresponds to a non-PEIM executable image 37, and there are no other PEIM modules to be found. As a result, the logic flows to a decision block 120 in which a determination is made to whether a FindFD PEIM has been dispatched. The FindFD PEIM is a specially configured PEIM that provides an interface that may be used to return the locations of other firmware devices in the computer platform, thereby enabling PEI modules stored in firmware devices other the BFD (FD0 in the example) to be used. In general, since the mechanism by which other firmware devices are located will not be standard, it cannot be contained in the execution ordering algorithm itself. Accordingly, it must be found and executed like any other PEIM.

In the example illustrated in FIG. 1, PEI module B corresponds to a FindFD PEIM. Since this PEIM has been dispatched, the answer to decision block 120 is YES (TRUE), causing the logic to proceed to loop end block 104 to find the next firmware device (FD1) and to make that FD current by incrementing the value of CurrFD to 1 (corresponding to FD1). It is noted that in one embodiment FindFD may be designed to find all of the firmware devices using a single operation, and then store a location reference for each of the firmware devices it identifies in a list or the like, which may then be held in an available processor or chipset register(s). In another embodiment, a service provided by the FindFD PEIM may be invoked on command by the dispatcher to find a next firmware device. In one embodiment, the firmware devices are identified by data contained in their respective headers that identifies them as firmware devices that contain firmware modules in accordance with the embodiments of the invention described herein.

In some instances, all of the PEIMs will be contained in the BFD, and there will be no need to find additional firmware devices. In these cases, the logic will proceed to a decision block 122 to determine if there were any PEIMs that were found in the BFD by not dispatched due to a yet to be dispatched service those PEIMs are dependent on. If all of the PEIMs were dispatched, the answer to decision block 122 is NO, and the algorithm is completed, as indicated by a block 124. If there are any PEIMs that are yet to be dispatched due to dependencies, the logic proceeds to a block 126 in which the CurrFD and PeimCnt values are reset to 0, whereupon the logic returns to start loop block 102 to perform another pass through the PEI modules of the BFD. An explanation of a similar pass through the PEI modules in FD0 in accordance with the present example is described below.

Returning to the present example, the next block encountered is a block 128 in which the PeimCnt value is incremented. As discussed above, the PeimCnt value is used to identify both PEIMs and FDs. In a decision block 130 a determination is made to whether this is the first time a currently processed firmware device has been “seen.” This can be checked by looking at the value of the bit corresponding to the current PeimCnt value: if the value is set (1), the current firmware device has been seen before, otherwise a cleared value (0) indicates that this is the first time the firmware device has been seen. If the answer to decision block 130 is YES, in one embodiment all of the PEIMs in that firmware device are verified (i.e., authenticated) in a block 130 to ensure that they have not been altered and/or corrupted from their original form. In general, this may comprise one of many well-known authentication schemes, such as a checksum scheme or an encryption scheme that is used to verify that the executable image of each PEIM has not been altered from its original form when it was created by the PEIM's developer or vendor. The reason for this is that there is a possibility of a third party providing firmware devices containing invalid PEIMs or providing downloadable PEIMs that purport to be PEIMs provided by legitimate vendors. Since invalid PEIMs might make a system unstable, or worse, cause damage to a system, it is desired that a verification operation similar to that discussed above be performed if such an operation is available. In accordance with one embodiment, this verification operation is provided by the FindFD PEIM.

After the verification is performed, the bit corresponding to the current PeimCnt value is set to 1 in the DispatchedPeimBitMap to indicate that the current FD has been seen. For example, as shown in FIG. 3, bit 3, which corresponds to firmware device FD1, has been set to 1 to indicate firmware device FD 1 has been seen (and thus, does not need to be verified again).

In a manner similar to that discussed above for firmware device FD0, the algorithm scans the code in the new firmware device (FD1), searching for PEI modules. In this instance, a pair of non-PIEM executable images 38 and 40 are encountered prior to reaching a header 42 corresponding to PEI module D. Upon identifying the header corresponds to a PEIM, the PeimCnt value is incremented in block 110 and it is determined in decision block 112 that PEI module D has yet to be dispatched, causing the logic to flow to decision block 114. Header 42 includes a CGL 44 and a PGL 46. As specified by CGL 44, PEI module D requires services corresponding to GUIDs C2 and E1 to be dispatched prior to execution of an executable image 48. Upon review of the GUIDs specified by the PGLs corresponding to the PEI modules that have been dispatched, neither of the services corresponding to GUIDs C2 and E1 has been dispatched. Accordingly, the answer to decision block 114 is NO, causing the logic to proceed to find the next PEIM in firmware device FD1 in block 108. In this instance, the header for a non_PEIM executable image 50 is encountered prior to reaching the end of the code in firmware device FD1, and thus there are no more PEIMs in the current firmware device.

At this point, the FindFD PEIM is invoked by dispatcher 12 to find the next firmware device (or look it up from a previously-produced list of firmware devices), which is firmware device FD2. As before, the PeimCnt value is incremented in block 128 (to 5), and it is determined in decision block 130 that the firmware device has not been seen before by examining bit 5 of the DispatchedPeimBitMap (which at this point would be marked with a 0). Again, all of the PEIMs in firmware device FD2 are verified in block 132, bit 5 in DispatchedPeimBitMap 20 is set to 1 in block 134 to indicate that firmware device FD2 has been seen, and the operations in the blocks contained between start and end loop blocks 102 and 108 are performed on firmware device FD2 in the same matter as were performed on firmware devices FD0 and FD1. During these operations, headers 52 and 54 respectively corresponding to two non-PEIM executable images are encountered, along with a header 56 corresponding to PEI module E. This header contains a CGL 58 containing no GUIDs and a PGL 60 containing GUIDs E1 and E2 corresponding to services provided by PEI module E upon execution of an executable image 62.

Upon encountering header 56, the PeimCnt value is incremented in block 110 to 6, and the answer to decision block 112 is NO, since PEI module E as yet to be dispatched when it is first encountered. In decision block 114, it is determined that the condition is met, since there are no GUIDs in CGL 58, indicating that PEI module E doesn't require any services to be dispatched prior to its own dispatch (i.e., it has no dependencies). As a result, PEI module E is dispatched in block 116, whereupon execution of executable image 62 produces the services identified by GUIDs E1 and E2. The bit corresponding to the current PeimCnt value (bit 6) is set in DispatchedPeimBitMap 20 in block 118, and the next PEIM is searched for in end loop block 108. Since there are no more PEIMs in firmware device FD2, the logic flows to decision block 120 and then to end loop block 104, wherein a search for the next firmware device is performed.

In this instance, all of the firmware devices have been found and a first pass has been performed on each of these FDs. As a result, there are no more firmware devices to process, and the logic flows to a decision block 136 in which a determination is made to whether there are any PEIMs that have yet to be dispatched. This determination can quickly be made by looking for any bits that are less than or equal to the current PeimCnt value that weren't set to 1 during the first pass through the firmware devices. In this instance, bits 0-6 are considered, wherein the value for each of bits 0, 2, and 4 are 0, indicating that there are three PEIMs that still need to be dispatched.

In response, the answer to decision block 136 is YES, causing the logic to proceed to block 126, in which the CurrFD and PeimCnt values are reset to 0. The logic then returns to start loop block 102 to begin a second pass through the firmware devices. As before, the second pass begins with firmware device FD0 (the BFD). The header of the first PEIM encountered is header 18, corresponding to PEI module A, which as yet to be dispatched and results in a NO answer to decision block 112. As before, a determination is made in decision block 114 to whether all of the services required by PEI module A (as specified by GUID C1 in CGL 22) have been dispatched. DispatchedPeimBitMap 20 is queried to identify the dispatched PEIMs, which in this instance are PEI modules B and E. The GUIDs in their respective PGLs 10 and 60 are retrieved (GUIDs B1, E1, and E2) and compared with GUID C1. Since GUID C1 is not contained in the lists of produced GUIDs, the answer to decision block is NO, and PEI module A still cannot be dispatched since it contains a dependency service (corresponding to GUID C1) that has yet to be produced.

As a result, the logic flows to end loop block 108 to begin processing the next PEIM. In this instance, the PEIM is PEI module B, which has been dispatched. Accordingly, the answer to decision block 112 is YES, and the next PEIM in firmware device FD1 is processed. This next PEIM, PEI module C, as yet to be dispatched, causing the determination in decision block 114 to be performed. Again, a comparison between the GUIDS of the services specified by the PEIM's CGL (CGL 36, which includes a GUID E1) are compared with the GUIDs in the PGLs corresponding to the dispatched PEIMs (which in this instance still comprise GUIDs B1, E1, and E2). Since GUID E1 is included in the latter list, an executable image 64 corresponding to PEI module C is dispatched in block 116, and bit 2 in DispatchedPeimBitMap 20 is set to 1 in block 118 (not shown). Upon execution, services having GUIDs C1 and C2 as specified in a PGL 66 contained in header 34 corresponding to PEI Module C and produced.

The logic then proceeds to end loop block 108 to find the next PEIM in firmware device FD0. Since PEI module C is the last PEIM in this FD, the logic proceeds to end loop block 104 to find the next firmware device (FD1). As before, the PeimCnt is incremented in block 128 to reflect moving to a new FD, and the determination of whether the FD has been seen before is made in decision block 130. In this case, FD1 has been seen before, so there is no need to re-verify its PEIMs, so blocks 132 and 134 are skipped and the PEIMs in firmware device FDl are processed in the normal manner. In this case, all of the GUIDs in CGL 44 corresponding to PEI Module D (i.e., GUIDs C2 and E1) have been produced during dispatch of the previously dispatched PEIMs (B, E, and C, which produced services identified by GUIDs B1, E1, E2, C1, and C2). As a result, executable image 48 of PEI module D may now be dispatched, whereupon its corresponding bit (4) is set to 1 in DispatchedPeimBitMap 20 (not shown).

The algorithm's processing then proceeds to perform dispatch operations on firmware device FD2, which contain the previously dispatched PEI module E. Since all of the PEIMs in FD2 have been previously dispatched, there are no dispatch operation to perform, causing the logic to eventually flow to decision block 136. At this point, all of the PEIMs have been dispatched, except for PEI Module A. Accordingly, bit 0 would still be cleared (0), and the answer to decision block 136 would be YES. As a result, a third pass through the platform's firmware devices begins.

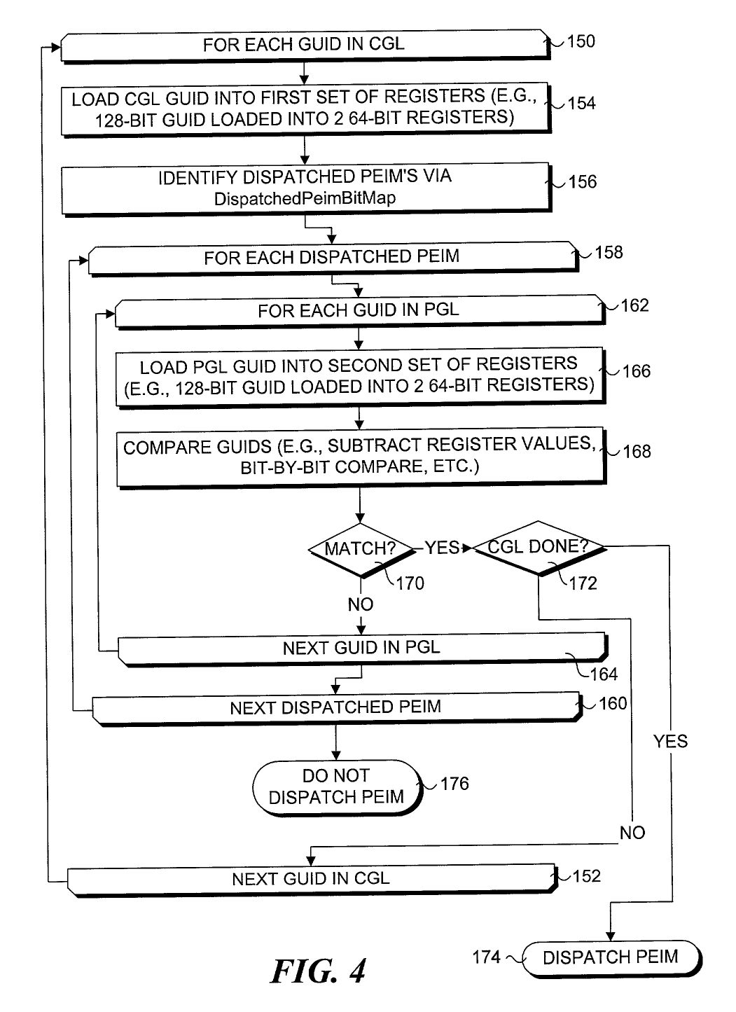

During this pass, PEI module A is again evaluated in decision block 114 to see if all of its dependent services identified by the GUIDs in its CGL 22 (i.e., GUID C1) have been produced. In this case, the service corresponding to GUID C1 was produced when PEI Module C was dispatched, so there are no service dependency problems, and PEI module A can finally be dispatched, producing a service identified by a GUID A1 in a PGL 68 contained in header 18. Upon further processing, the logic again returns to decision block 136, whereupon a determination is made that all of the PEIMs have been dispatched, completing the execution ordering algorithm. As identified by a execution dispatch path diagram 70 in FIG. 1, dispatcher 12 may dispatch the PEIMs in either an order of B, E, C, D, and A, or an order of B, E, C, A, and D. In accordance with the diagram's structure, whenever two or more PEIMs occupy the same level, the order of execution of those PEIMs is optional. Thus, the execution ordering algorithm is termed a “weak” ordering algorithm because it may produce one of several “legal” orders by which all service dependencies are resolved. As discussed above, in one embodiment the present invention is able to perform an ordered dispatch of the PEI modules in a pre-memory execution environment, which means that normal system memory (i.e., the system's RAM memory) is not yet available. With reference to the flow chart of FIG. 4, the determination of whether all services required by a given PEI module have been produced (decision block 114 or FIG. 2) in accordance with one embodiment of the invention that does not use system memory proceeds as follows. As discussed above, the determination of whether a given PEI module may be dispatched is made by comparing the GUIDs in the CGL of the PEI module with the GUIDs contained in the PGLs of previously dispatched PEI modules to ascertain that all services required for the given PEI module have been dispatched prior to dispatch of that PEI module. Accordingly, the various operations defined by blocks contained within start and end loop blocks 150 and 152 are performed on each GUID in the CGL of the PEI module.

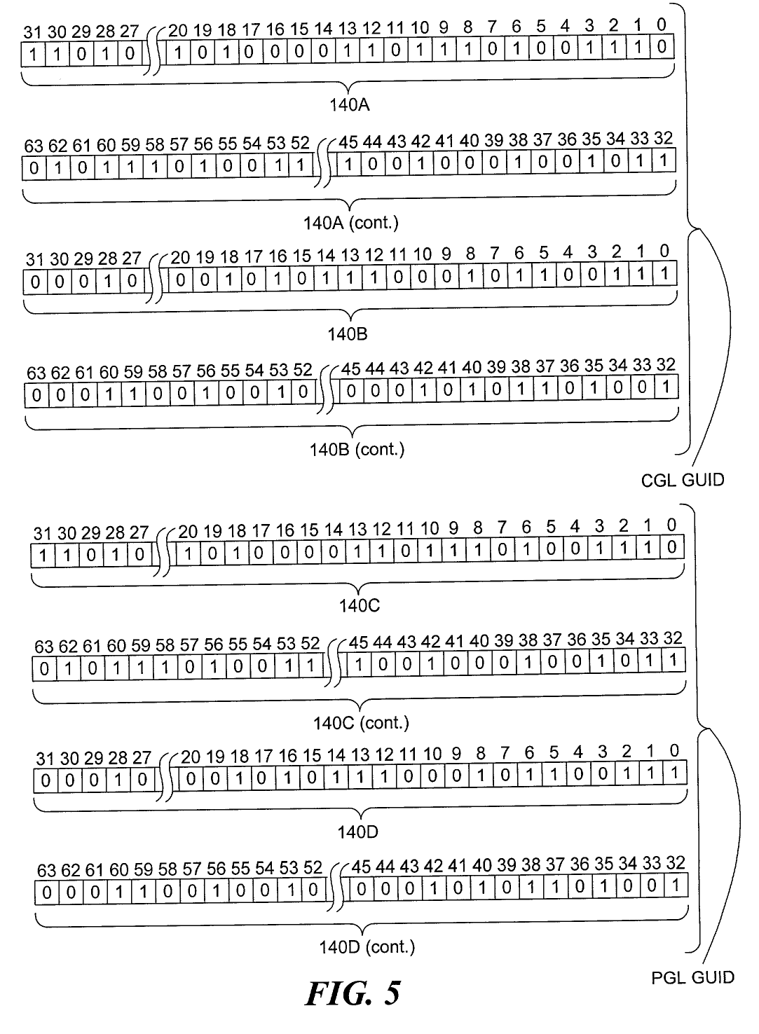

The first operation for a given CGL GUID is to load the GUID into a first set of registers. Depending on the length of the GUID and the size of the registers, the set of registers may comprise one or more registers. In the embodiment discussed above, each GUID comprises a 128-bit value. In one embodiment corresponding to an Intel PENTIUM III processor, the processor includes several 64-bit MMX registers, as depicted by registers 140A, 140B, 140C and 140D in FIG. 5. Accordingly, 64-bit halves of the 128-bit CGL GUID may be loaded in the first two registers 140A and 140B, which correspond to a first set of registers in which the CGL GUID is loaded.

Next, the dispatched PEI modules are identified via the DispatchPeimBitMap in a block 156, as described above. As provided by start and end loop blocks 158 and 160, the operations corresponding to blocks contained within these loop end points are performed for each dispatched PEI module, as necessary. Similarly, as provided by start and end loop blocks 162 and 164, the operations corresponding to the blocks contained within these loop end points is performed for each GUID in the PGL of the dispatched PEI module that is currently being processed. First, in a block 166, the PGL GUID is loaded into a second set of registers, wherein the number of registers will again depend on the processor architecture. As shown in the lower half of FIG. 5, in one embodiment the PGL GUID is loaded into registers 140C and 140D, which comprise a second set of 64-bit registers.

In a block 168, the CGL and PGL GUIDs are compared to see if they are the same. This comparison can be performed using one of many well-known techniques, such as register subtraction or bit-by-bit comparison. In accordance with one subtraction scheme, the 64-bit value in register 140C would be subtracted from the 64-bit value in register 140A, while the 64-bit value in register 140D would be subtracted from the 64-bit value in register 140B. The actual subtraction process may depend on the architecture of the processor. For example, for 32-bit processors, the 64-bit values in registers 140A, 140B, 140C, and 140D may need to be broken into 32-bit chunks and loaded into appropriate 32-bit registers to perform the subtraction operation, as will be understood by those skilled in the microprocessor arts.

Based on the result of the comparison operation of block 168, a determination is made in a block 170 to whether the CGL and PGL GUIDs are the same. In the example depicted in FIG. 5, the CGL and PGL GUIDs are identical, so the result of decision block 170 would be YES (TRUE). In accordance with a TRUE result, the logic proceeds to a decision block 172 in which a determination is made to whether the current CGL GUID is the last GUID in the CGL. If the answer is YES (TRUE), this indicates that all of the required services for the PEI module have been dispatched, and, accordingly, the PEI module is dispatched in a block 174.

If the CGL and PGL GUIDs don't match, the answer to decision block 170 is NO (FALSE), and the logic proceeds to compare the next GUID in the PGL of the dispatched PEI module that is currently being processed with the current CGL GUID. This GUID comparison process is repeated for each GUID in the dispatched PEI module(s) until either the answer to decision blocks 170 and 172 is TRUE, or there were no matched found after comparing the PGL GUIDs of all of the dispatched PEI modules to the current CGL GUID. In this latter instance, the logic proceeds to an exit block 176 that indicates that the PEI module should not be dispatched, since a GUID in its CGL did not match any GUID in the PGLs of the previously dispatched PEI modules, indicating that a required service for the PEI module has yet to be dispatched.

Exemplary Computer System for Practicing the Invention

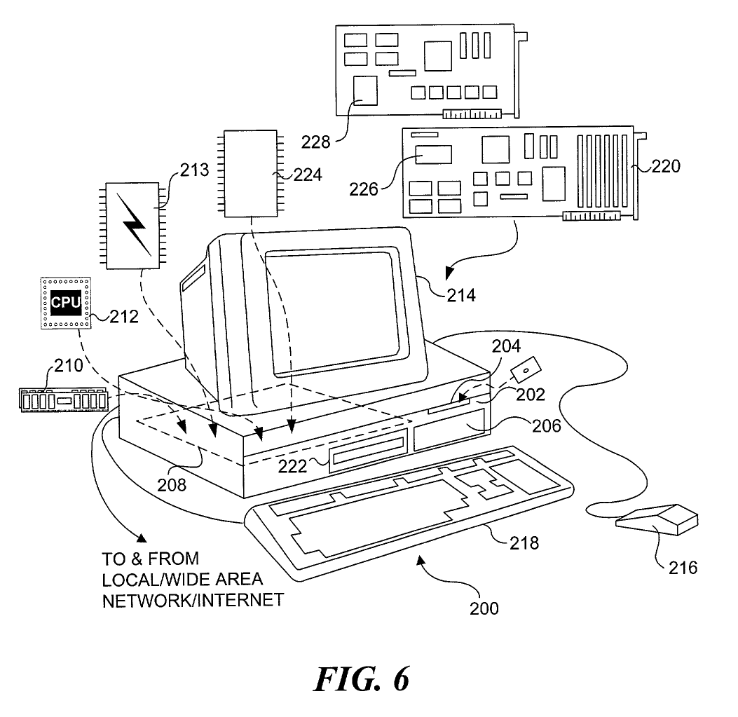

With reference to FIG. 6, a generally conventional computer 200 is illustrated, which is suitable for use in connection with practicing the present invention, and may be used for running firmware instructions that implement the various operations of the invention discussed above. Examples of computers that may be used include PC-class systems operating the Windows NT, 95, 98, 2000, or XP operating systems, various workstations operating UNIX-based operating systems, and various computer architectures that implement LINUX operating systems. Computer 200 is also intended to encompass various server architectures, as well as computers and servers having multiple processors.

Computer 200 includes a processor chassis 202 in which are mounted a floppy disk drive 204, a hard drive 206, a motherboard 208 populated with appropriate integrated circuits including memory 210, one or more processors (CPUs) 212, and a power supply (not shown), as are generally well known to those of ordinary skill in the art. It will be understood that hard drive 206 may comprise a single unit, or multiple hard drives, and may optionally reside outside of computer 200. The motherboard also includes a boot firmware device (BFD) 213 on which at least early firmware instructions are stored to initialize the computer during a cold boot or in response to a system reset, including the PEI CORE instructions discussed above. A monitor 214 is included for displaying graphics and text generated by software programs and program modules that are run by the computer. A mouse 216 (or other pointing device) may be connected to a serial port (or to a bus port or USB port) on the rear of processor chassis 202, and signals from mouse 216 are conveyed to the motherboard to control a cursor on the display and to select text, menu options, and graphic components displayed on monitor 214 by software programs and modules executing on the computer. In addition, a keyboard 218 is coupled to the motherboard for user entry of text and commands that affect the running of software programs executing on the computer.

Computer 200 also includes a network interface card 220 or built-in network adapter for connecting the computer to a computer network, such as a local area network, wide area network, or the Internet. The computer may also include one or more peripheral device cards 221, such as video cards, sound cards, SCSI device drive cards, etc., or circuitry equivalent thereto that is provided on motherboard 208. Computer 200 may also optionally include a compact disk-read only memory (CD-ROM) drive 222 into which a CD-ROM disk may be inserted so that executable files and data on the disk can be read for transfer into the memory and/or into storage on hard drive 206 of computer 200. Other mass memory storage devices such as an optical recorded medium or DVD drive may be included.

The various PEI modules that are operated on by the invention may be provided in BFD 213, or in other firmware devices accessible to the computer. For example, these firmware devices may include an add-on firmware device 224 coupled to motherboard 208, or option ROMs contained on peripheral cards, depicted as option ROMs 226 and 228.

The instructions comprising the firmware that causes the CPU to implement the operations of the present invention that have been discussed above will likely be provided with BFD 213, or provided in an upgrade BIOS component that is used to replace or augment BFD 213. In some instances, BFD 213 will comprise a flash memory component (or a similar rewritable component), whose instructions may be rewritten with a coded firmware image that is either stored on a floppy disk, CD, or DVD, or downloaded as a carrier wave to computer 200 via a computer network such as the Internet.

Although the present invention has been described in connection with a preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

What is claimed is:

1. A method comprising:
identifying any services that must be produced prior to executing each of a plurality of firmware modules;
identifying services produced by each of said plurality of firmware modules upon execution of that firmware module; and
determining an execution order in which said plurality of firmware modules may be properly executed, said execution order being determined during an initialization process of a computer system prior to main memory for the computer system being accessible.

2. The method of claim 1, wherein there are at least two firmware modules from among said plurality of firmware modules that are created by at least two different firmware suppliers.

3. The method of claim 1, wherein the operations of the method are implemented through a set of firmware instructions corresponding to a dispatcher that is executed during the initialization process.

4. The method of claim 1, wherein determining the execution order comprises the operations of:
monitoring services that are produced by firmware modules when they are executed; and
dispatching each firmware module for execution in response to determining that all of the services that must be produced prior to execution of that firmware module have produced,
wherein the execution order corresponds to an order in which said plurality of firmware modules are dispatched.

5. The method of claim 1, wherein said plurality of firmware modules are stored on at least two different firmware devices.

6. The method of claim 1, wherein each firmware module includes an executable body comprising a plurality of instructions that produce one or more services when executed and a header containing information identifying any services that must be produced prior to execution of the firmware module.

7. The method of claim 6, wherein the header further includes information identifying said one or more services that are provided when the executable body of the firmware module is executed.

8. The method of claim 7, wherein the execution order is determined by performing the operations of:
searching for any firmware modules that may be accessed by the computer system;
upon finding each firmware module,
parsing its header to determine any services that must be produced prior to its execution;
parsing the headers of any firmware modules that have been previously executed to identify all of the services that have been previously produced;
comparing the services that must be produced prior to execution of the firmware module to the services that have been previously produced to determine if the firmware module can be executed; and
dispatching the executable body of the firmware module for execution if all of the services that must be produced prior to its execution have been previously produced.

9. The method of claim 8, wherein the operations of the method are performed iteratively, as required, to determine whether a currently evaluated firmware module may be dispatched during a current pass through a firmware device on which the current firmware module is stored until all of the firmware modules have been dispatched for execution.

10. The method of claim 8, further comprising storing data identifying which firmware modules have been executed.

11. The method of claim 8, further comprising searching for any firmware devices that are accessible to the computer system that may contain one or more firmware modules from among said plurality of firmware modules.

12. The method of claim 11, further comprising verifying an integrity of each firmware module contained in a given firmware device prior to enabling those firmware modules from being dispatched for execution.

13. The method of claim 12, further comprising storing data identifying whether the integrity of the firmware modules for a given firmware device has been verified.

14. A machine-readable media on which a plurality of instructions are stored that when executed by a processor enable a computer system to perform the operations of:
searching for firmware modules that contain firmware that is used to initialize the computer system during an initialization process;
for each firmware module that is found, identifying any services that must be produced prior to executing that firmware module;
identifying services produced by each of firmware modules upon execution of that firmware module; and
dispatching the firmware modules for execution in an execution order that is determined during the initialization process prior to initializing main memory for the computer system, said execution order ensuring that any services required by each firmware module has been previously produced prior to dispatching that firmware module.

15. The machine-readable media of claim 14, in which the machine-readable media comprises a flash memory component.

16. The machine-readable media of claim 14, in which the machine-readable media comprises a carrier wave that may be transmitted over a computer network.

17. The machine-readable media of claim 14, wherein execution of said plurality of instructions further performs of the operations of:
in response to execution of a firmware module, storing dispatch data from which any services provided by that firmware module can be identified;
using the dispatch data to determine if any non-dispatched firmware module may be dispatched by verifying that all services that must be produced prior to execution of that firmware module have been previously produced; and
dispatching firmware modules for which a corresponding verification is made for execution by the processor.

18. The machine-readable media of claim 14, wherein each firmware module includes an executable body comprising a plurality of instructions that produce one or more services when executed and a header containing information identifying any services that must be produced prior to execution of the firmware module and identifying said one or more services that are provided when the executable body of the firmware module is executed, and wherein the execution order is determined by performing the operations of:
parsing the header of a currently evaluated firmware module to determine any services that must be produced prior to its execution;
determining which firmware modules have been previously executed;
parsing the headers of any firmware modules that are determined to have been previously executed to identify all of the services that have been previously produced;
comparing the services that must be produced prior to execution of the firmware module to the services that have been previously produced to determine if the firmware module can be executed; and
dispatching the executable body of the firmware module for execution by the processor if all of the services that must be produced prior to its execution have been previously produced.

19. The machine-readable media of claim 18, wherein execution of the instructions by the processor further causes the computer system to perform the operation of storing data identifying which firmware modules have been executed.

20. The machine-readable media of claim 19, wherein the data are stored in a processor register.

21. The machine-readable media of claim 18, wherein execution of the instructions by the processor further cause the computer system to perform the operation of searching for any firmware devices that are accessible to the computer system that may contain one or more firmware modules.

22. The machine-readable media of claim 21, wherein the firmware modules are stored on two or more firmware devices, and the operations of the method are performed iteratively, as required, to determine whether a currently evaluated firmware module may be dispatched during a current pass through a firmware device on which the current firmware module is stored until all of the firmware modules have been dispatched for execution by the processor.

23. A non-volatile memory component comprising:
a boot firmware device on which a plurality of firmware instructions are stored, including,
a set of instructions to perform early initialization of a computer system in which the boot firmware may be implemented upon execution of those instructions by a processor in the computer system, said early initialization being performed during a cold boot operation or in response to reset event;
a set of instructions corresponding to a dispatcher that when executed by the processor performs the operations of,
determining an execution order in which a plurality of firmware modules stored on the boot firmware device and/or one or more other firmware devices that may be accessed by the computer system may be properly executed based on service dependency requirements of each firmware module and services provided by each firmware module, said execution order being determined during an initialization process of the computer system that includes the early initialization and is prior to main memory for the computer system being accessible; and
dispatching the firmware modules for execution by the processor based on the execution order.

24. The non-volatile memory component of claim 23, wherein each firmware module includes an executable body comprising a plurality of instructions that produce one or more services when executed and a header containing information identifying any services that must be produced prior to execution of the firmware module and identifying said one or more services that are provided when the executable body of the firmware module is executed, and wherein the dispatcher determines the execution order by performing the operations of:
parsing the header of a currently evaluated firmware module to determine any services that must be produced prior to its execution;
determining which firmware modules have been previously executed;
parsing the headers of any firmware modules that are determined to have been previously executed to identify all of the services that have been previously produced;
comparing the services that must be produced prior to execution of the firmware module to the services that have been previously produced to determine if the firmware module can be executed; and
dispatching the executable body of the firmware module for execution by the processor if all of the services that must be produced prior to its execution have been previously produced.

25. The non-volatile memory component of claim 24, wherein execution of the dispatcher further performs the operation of storing data identifying which firmware modules have been executed in one or more registers accessible to the processor.

26. The non-volatile memory component of claim 23, wherein the operations of the method are performed iteratively, as required, to determine whether a currently evaluated firmware module may be dispatched during a current pass through a firmware device on which the current firmware module is stored until all of the firmware modules have been dispatched for execution by the processor.

27. The non-volatile memory component of claim 23, further comprising a set of instructions corresponding a find firmware device firmware module that when executed performs the operation of finding any firmware devices that are accessible to the computer system that may contain one or more firmware modules from among said plurality of firmware modules.

28. The non-volatile memory component of claim 27, wherein execution of the find firmware device firmware module further performs the operation of verifying an integrity of each firmware module contained in each firmware device that is found.

29. The non-volatile memory component of claim 28, wherein execution of one of the dispatcher or the find firmware device firmware module further performs the operation of storing data identifying whether the integrity of the firmware modules for a given firmware device has been verified.

30. The non-volatile memory component of claim 29, wherein the non-volatile memory component comprises a flash memory component.
